(19) United States
(12) Patent Application Publication
(10) Pub. No.: US 2022/0001711 A1
(43) Pub. Date: Jan. 6, 2022

(54) COMPRESSION-TENSION COMPONENT FOR CONNECTING MECHANICAL PARTS

(71) Applicant: Gemini Composites LLC, Seattle, WA (US)

(72) Inventors: Paolo FERABOLI, Seattle, WA (US); Bonnie WADE, Seattle, WA (US)

(73) Assignee: Gemini Composites LLC, Seattle, WA (US)

(21) Appl. No.: 17/338,832

(22) Filed: Jun. 4, 2021

Related U.S. Application Data
(60) Provisional application No. 63/046,958, filed on Jul. 1, 2020.

(51) Int. Cl. B60G 7/00

(52) U.S. Cl. CPC B60G 7/001; B60G 2206/013; B60G 2206/81; B60G 2206/7101; B60G 2206/16

(57) ABSTRACT

A fiber reinforced plastic compression-tension component for connecting two mechanical parts is provided. The component has a curved connection member connecting two coupling units. A portion of the curved connection member has a substantially U-shaped cross-sectional geometry. The U-shaped cross-sectional geometry may comprise upright portions with winglets extending outward. The geometry of the compression-tension component allows it to replace a heavier compression-tension component made of metal and having a different geometry.

### CROSS REFERENCE TO RELATED APPLICATIONS

This application claims the benefit of priority from U.S. Provisional Application No. 63/046,958 filed Jul. 1, 2020, which is incorporated herein by reference in its entirety.

### BACKGROUND OF THE INVENTION

### Field of the Invention

The present invention is directed to compression-tension components which are employed to connect mechanical parts which impart tension, compression, or both to the component. Such compression-tension components are employed in vehicle construction, for example, as suspension arms in wheel assemblies. However, the materials and concepts provided herein may be applied to any connective structure which must perform under applied tension and/or compression stress where two mechanical parts are connected to communicate movement of one part to another.

Much effort is being directed to increased fuel performance for vehicles of all types. In one aspect of this work, fuel performance may be increased by minimizing the weight of component parts while at the same time maintaining strength and durability of the part. In general terms, the transition from steel to aluminum to plastic components, especially fiber reinforced plastics (FRP), is under scrutiny. This is of interest considering that the density of steel is commonly in the range of 7.75 to 8.05 g/cm3, the density of aluminum is 2.7 g/cm³, and the density of plastics is about 0.6 g/cm³ to about 3.0 g/cm³. The density of fiber-reinforced plastics is dependent upon the matrix plastic, the fibers employed for reinforcement, and the content of the fibers, and the density may vary from 1.0 g/cm³ to 3.8 g/cm³.

By starting with lower densities than steel and aluminum, fiber reinforced plastics may offer significant reduction in component part weight. However, it has generally been determined that when direct substitution of fiber reinforced plastic for aluminum or steel in compression-tension components is attempted, the FRP part fails at lower compressive and/or tensile loads than the original aluminum or steel part.

Often, the structure of the compression-tension component is constrained by shape and geometrical requirements, which further aggravate the lower failure load of the FRP part. Many such parts are non-straight (e.g., may be curved or as further defined below) and must fit into a space confined by other component and structural parts. Additionally, the requirement that the part must include assemblies to couple with other mechanical parts leads to further design difficulties.

Thus, there is a need for FRP compression-tension components, such as a non-straight part of a suspension arm assembly, which meet the requirements for strength and stiffness while also conforming to the geometric design constraints.

### SUMMARY

The present invention in a first structural embodiment provides a compression-tension component for connecting two mechanical parts, comprising: a non-straight connection member having two ends and a coupling unit at each end of the connection member; wherein the compression-tension component comprises a fiber reinforced plastic, an average density of the compression-tension component is 1.8 g/cm³ or less, and at least a portion of the connection member comprises a cross-sectional geometry which is substantially U-shaped.

In an aspect of this first structural embodiment, at least a portion of the connection member of the compression-tension component comprises a cross-sectional geometry which has a symmetric U-shape. In one embodiment, the U-shape may be described as a “C-shape,” or a “C-channel.”

In an aspect of this first structural embodiment, at least a portion of the connection member of the compression-tension component comprises a cross-sectional geometry which is a partially symmetric U-shape. In another embodiment, the U-shape may be considered asymmetric.

In an aspect of the first structural embodiment, the fiber reinforced plastic comprises at least one fiber selected from the group consisting of carbon fibers, glass fibers, and aramid fibers, which can include but is not limited to fibers selected from those families such as basalt, graphite or Zylon and various others, and in a special aspect the fiber reinforced plastic comprises carbon fibers.

In a further aspect of the first structural embodiment, the substantially U-shaped structure comprises a horizontal base and two generally vertical upright portions wherein at least one of the upright portions comprises a winglet extending outward at an angle to an interior surface of the upright portion at the end of the upright portion. In a further special aspect both upright portions comprise a winglet. In configurations according to these aspects, at least one of the winglets extends outward horizontally from the end of the upright portion.

In other embodiments, at least one of the winglets extends outward from the end of the upright portion at an angle above or below a horizontal direction from the upright portion.

In a another further aspect of the first structural embodiment, the substantially U-shaped structure comprises a horizontal base and two generally vertical upright portions wherein at least one of the upright portions may or may not comprise a winglet. In one embodiment, a winglet, if present, may or may not extend outward at an angle to an inner surface of the upright portion at the end of the upright portion. In one embodiment, both upright portions do not have a winglet.

In an aspect of the first structural embodiment, the U-shaped structure comprises a horizontal base and two generally vertical upright portions. These upright portions may or may not be equal to each other. Furthermore, at least one of the upright portions comprises a winglet extending outward at an angle to the line of the upright portion at the end of the upright portion and in a special form of this aspect both upright portions comprises a winglet extending outward at an angle to an interior surface of the upright portion at the end of the upright portion. According to these aspects one or both of the winglets may extend outward horizontally to the interior surface of the upright portion.

In another aspect of the first structural embodiment, the fiber reinforced plastic comprises continuous fibers and in special forms of this aspect the continuous fibers may be unidirectional or woven into a fabric or a combination thereof. In a further special form of this aspect the continuous fibers may be arranged in a substantially uniform microstructure throughout the structure of the compression-tension component. According to these aspects a tow of the continuous fibers may be from 1 K to 80 K.

In more detailed aspects of the first structural embodiment, the cross sectional geometry of the connection member of the compression-tension component varies independently extending toward each coupling unit from a region in an interior of the connection member where a cross-sectional geometry comprising the substantially U-shaped structure is present.

In further description of these more detailed aspects of the first structural embodiment, a horizontal extension outward of the winglets is greatest in the interior region of the connection member and decreases in each direction going toward each end of the non-straight connection member.

In further description of these more detailed aspects of the first structural embodiment, a cross sectional geometry of the connection member near a coupling unit may comprise a horizontal base having at least one upright portion different from the substantially U-shaped structure of the interior of the connection member.

In one explicit embodiment, the present invention provides a suspension arm for a vehicle.

In further aspects of this explicit embodiment, the suspension arm comprises at least one attachment unit in the connection member and additionally, the at least one attachment unit comprises a cavity for insertion of a fastening device.

In another aspect of the first structural embodiment, the connection member minimizes the changes in sign of the axial stress determined under tension or compression analysis.

In a further aspect of the first embodiment, the compression-tension component is a compression molded structure made using a mainstream composite technology, which can include but is not limited to a sheet molding compound (SMC) technology, a prepreg (a fiber-resin combination) technology and/or a liquid molding technology (RTM or various other types).

In other explicit embodiments the present invention includes a suspension member, comprising: a non-straight arm having two ends and an opening at each end of the arm; wherein the suspension member comprises a fiber reinforced plastic, an average density of the suspension member is 1.8 g/cc or less, and the suspension member comprises a cross-sectional geometry which is substantially U-shaped.

Further included is an automotive suspension member, comprising: a non-straight arm having two ends and an opening at each end of the arm; wherein the automotive suspension member comprises a carbon fiber reinforced plastic and the arm is made by a compression molding process, and the arm comprises a cross-sectional geometry which is substantially U-shaped.

Further included is a suspension member, comprising: a crooked or non-straight arm having two ends and an opening at each end of the arm; wherein the suspension member comprises a fiber reinforced plastic and the non-straight arm is made by a low flow SMC molding process, the suspension member comprises a cross-sectional geometry which is substantially U-shaped.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A shows an isometric front perspective view of a prior art aluminum suspension arm.

FIG. 1B shows a side view of the prior art aluminum suspension arm of FIG. 1A.

FIG. 1C shows a top plan view of the prior art aluminum suspension arm of FIG. 1A.

FIG. 2A shows a side view of the prior art aluminum suspension arm of FIG. 1A with section markings.

FIGS. 2B-2K each show respective cross-sectional views along lines 2B-2K.

FIG. 3A shows an isometric front perspective view of a suspension arm.

FIG. 3B shows a side view of the suspension arm of FIG. 3A.

FIG. 3C shows a top plan view of the suspension arm of FIG. 3A.

FIG. 4A shows a front elevational view of the suspension arm of FIG. 3A with section markings.

FIGS. 4B-4K each show respective cross-sectional views along lines 4B-4K.

FIG. 5A shows a front perspective view of a suspension arm.

FIG. 5B shows a side view of the suspension arm of FIG. 5A.

FIG. 5C shows a top plan view of the suspension arm of FIG. 5A.

FIG. 5D shows a cross-sectional view along line 5D.

### DETAILED DESCRIPTION OF THE PREFERRED EMBODIMENTS

The present inventors have conducted extensive studies directed to the replacement of aluminum compression-tension components, especially suspension arms for vehicular wheel assemblies with lower weight fiber reinforced plastic (FRP) materials and specific three dimensional designs.

The methods and descriptions which follow may be applied to replace metal compression-tension components with those made of FRP, especially suspension arms for vehicular wheel assemblies, and even more particularly suspension arms which have a non-straight shape. Thus, it is noted that although much of the following description is directed to suspension arms, the materials and structures to be described are generally applicable to any component which is designed to function under compression and/or tension stress forces.

### Materials

Fiber reinforced plastic materials are conventionally known by one of skill in the art and contain at least one resin component and at least one reinforcing fiber.

The resin component may be a thermoplastic or thermosetting resin, and each type of resin may be applied to a selected end use device. For example, thermoplastic resins may include polyamides, such as but not limited to PA6 and PA66 or polypropylene, while known thermosetting resins in the FRP industry include epoxy and vinyl resins. Generally, when the unit is produced by a sheet molding process, thermosetting resins are employed; and when formed by injection molding, thermoplastic resins are employed. These examples are not limiting, and resins conventionally employed in the industry are included in the present invention.

The reinforcing fibers may include at least one mainstream composite reinforcing fiber, which can include carbon fibers, glass fibers and aramid fibers, which can include but are not limited to fibers selected from those families such as basalt, graphite or Zylon and various others. In some embodiments carbon fibers may be preferred, and carbon fiber reinforced plastics (CFRP) are well-known in the art.

The fibers may be continuous or discontinuous in the resin matrix. In the case of discontinuous reinforced plastics, the fibers are randomly oriented in the reinforced plastic matrix and are adhered to one another by the resin. The length of the discontinuous fibers may vary from 0.5 to 100 mm, alternately 25-50 mm.

### Device Design and Three Dimensional Geometry

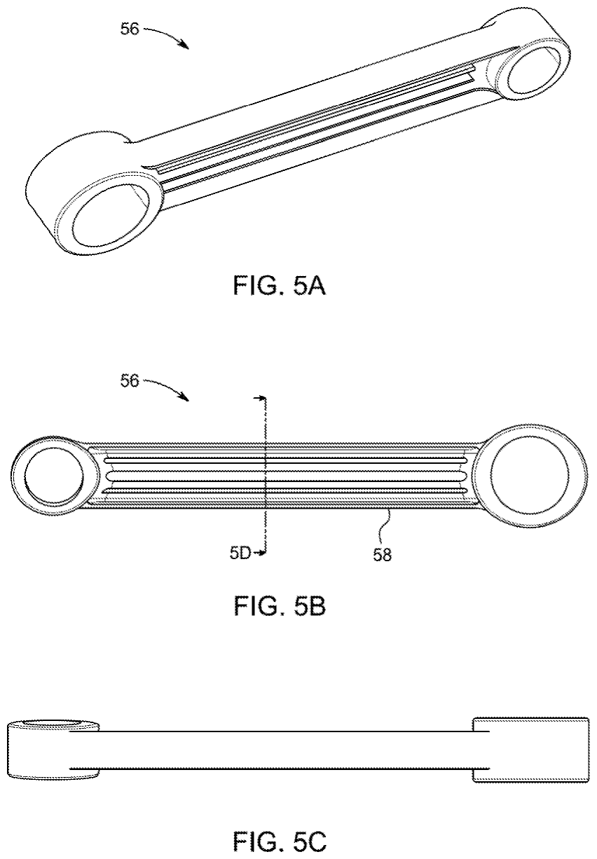

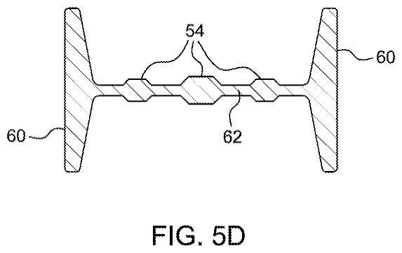

Compression-tension components, especially suspension arms for vehicular wheel assemblies, may be loaded in tension or compression at the ends thereof, and as such could be made into a straight bar, such as a bar having a generally prismatic shape with a substantially similar cross-section throughout its longest axis. The load sustained by a straight bar component would thus resolve into a pure axial tension or compression stress state given by the applied load divided by the cross section area (P/A). In an ideal case, the compression-tension component could be in the form of a straight bar as shown in FIGS. 5A-5C. The load sustained by the component of FIGS. 5A-5C resolves into a pure axial tension or compression stress state given by the applied load divided by the cross section area (P/A).

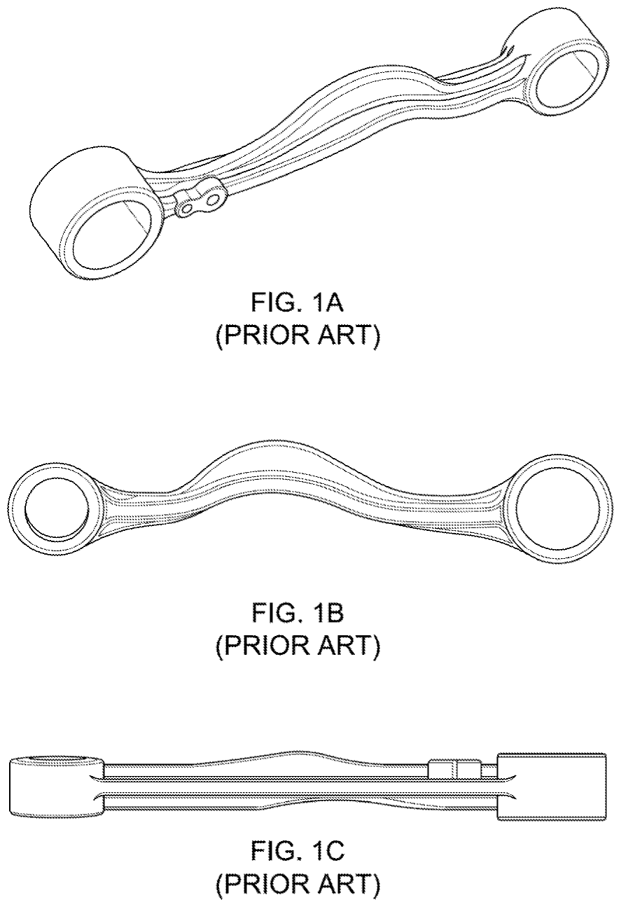

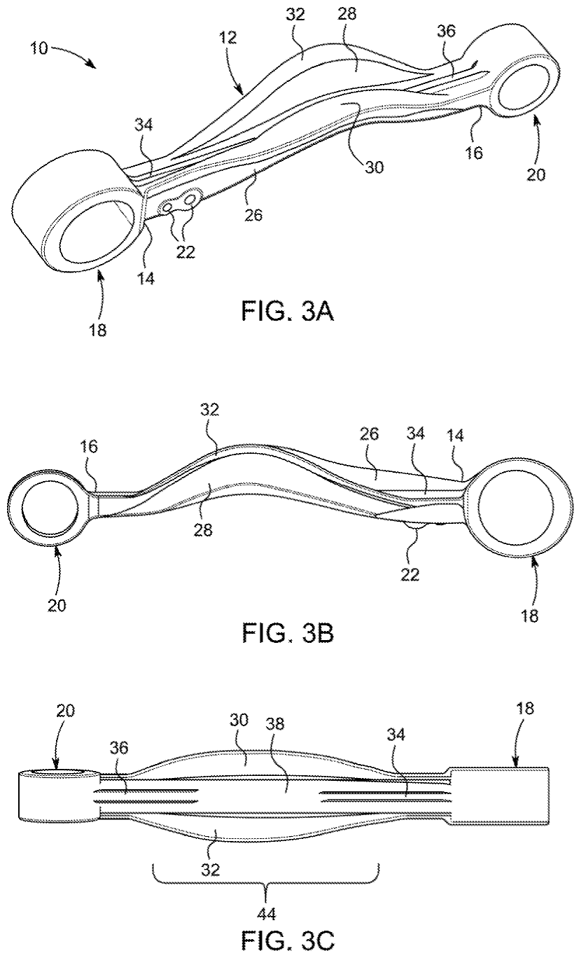

However, other geometric constraints due to location and requirements for adjacent parts may preclude a straight bar geometry. These constraints may require the component to fit into a complex three dimensional spatial configuration that often includes bends in the component structure. The result of these one or more bends is a non-straight or crooked part, such as those shown in FIGS. 1A-1C and FIGS. 3A-3C.

These bends in the geometry give rise to bending stresses, which superimpose the pure axial tension or compression stresses experienced by the structural part/component/element and in turn greatly increase the overall stress state experienced by the component. The overall stress state can be 3 to 7 times higher than the nominal axial stress state calculated by P/A. These bending stresses may vary through the thickness of the component, and may change sign at the neutral axis. Furthermore, depending on the geometry of the component, the stresses may be such that at given locations they can change the sign of the stress state. For example, if the component is loaded in compression, the part may experience compressive stresses in most locations, but at specific points the stress state may switch sign and become purely tensile. Where the sign of the stress state changes, there is a stress concentration point, and such point can lead to premature failure of the component under load in a compression-tension component such as a suspension arm. Thus, the design of the compression-tension components must take these stress points into account.

The inventors have also discovered that the material must work in unison with the component geometry in order to maximize effectiveness. Using the wrong material will result in lower performance parts that may not be adequate to replace an existing metal part, such as a suspension arm.

The Example describes a reduced weight replacement suspension arm for a conventionally employed aluminum suspension arm. Although the Example discloses an explicit embodiment of a compression-tension arm, the present invention is not intended to be limited only to that explicit embodiment and includes multiple embodiment aspects useful as compression-tension components as disclosed herein.

Thus, in a first embodiment the present invention provides a compression-tension component 10 for connecting two mechanical parts, comprising:

a non-straight connection member 12 having two ends 14/16 and a coupling unit 18/20 at each end of the connection member; wherein the compression-tension component comprises a fiber reinforced plastic, an average density of the compression-tension component is 1.8 g/cc or less, and at least a portion of the connection member comprises a cross-sectional geometry which is substantially U-shaped. More particularly, the portion or portions of the connection member comprising a substantially U-shaped cross-sectional geometry is found in non-straight portions of the connection member 12, in the central portion or towards or at the end, or some combination thereof. FIG. 3C shows a portion 44 of the connection member that comprises a substantially U-shaped cross-sectional geometry.

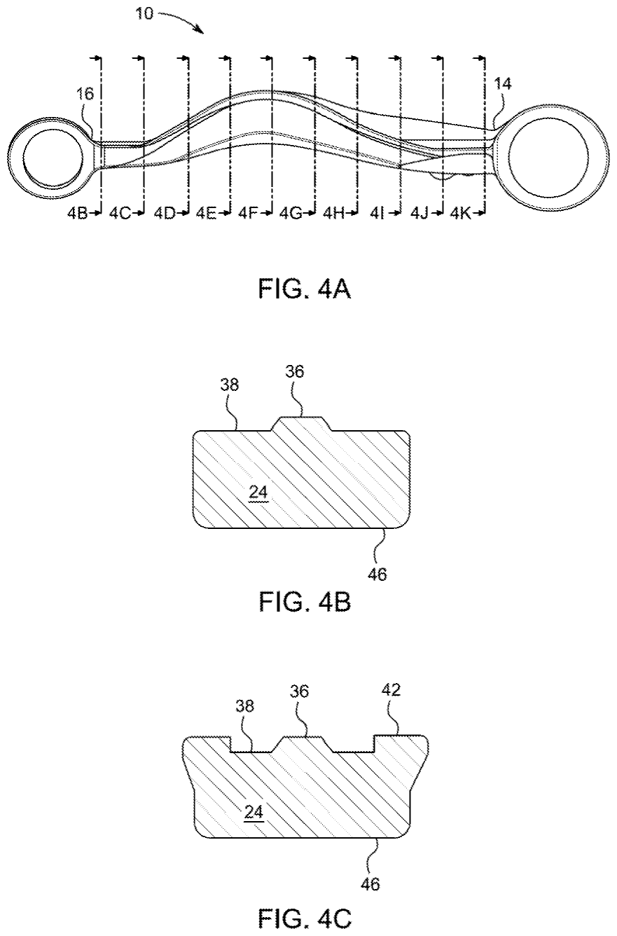

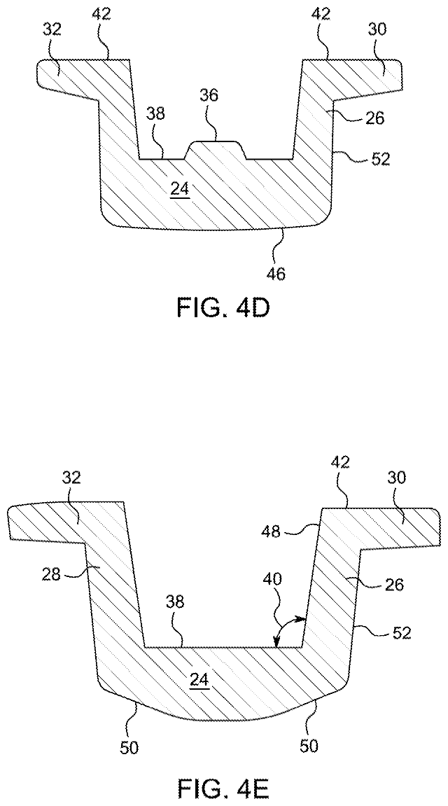

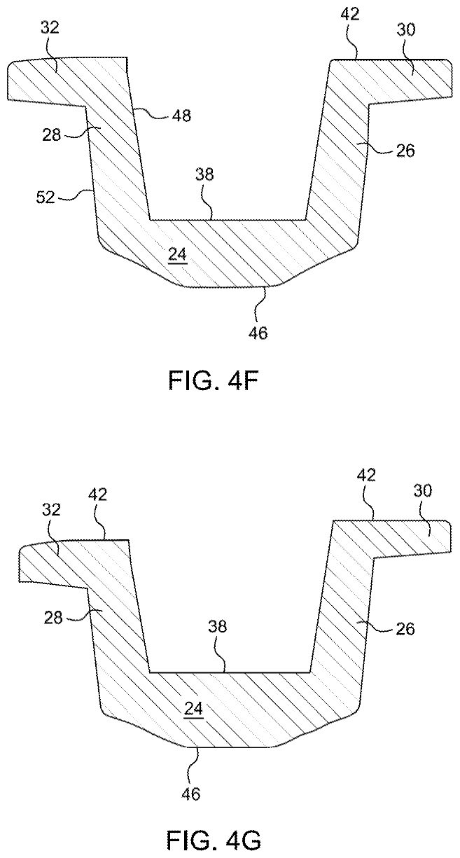

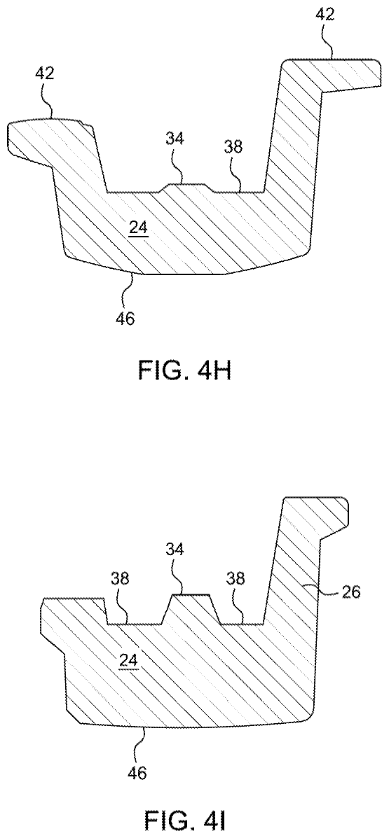

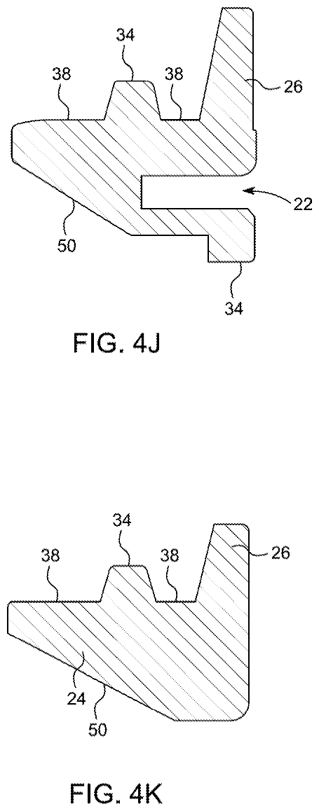

Depending on structural constraints, which may be imposed on the compression-tension component according to this first embodiment, there may be variation in the structure of the connection member. For example, in one aspect at least a portion of the connection member 12 comprises a cross-sectional geometry which has a symmetric U-shape. For example, cross-sections shown by FIGS. 4D-4F show symmetric U-shapes. In one embodiment, symmetric U-shapes may be considered to have generally vertical upright portions 26/28 that are “equal.” In other embodiments, the cross-sectional geometry has a non-symmetric U-shape. For example, cross-sections shown by FIGS. 4G-4H show non-symmetric U-shapes. In still further embodiments, the cross-sectional geometry of the component part may change between a symmetric and non-symmetric U-shape along its length. For instance, this change in symmetric and non-symmetric U-shape cross-sections is evident by the fact that the symmetric U-shapes of FIGS. 4D-4F and the non-symmetric U-shapes of FIGS. 4G-4H are cross-sections taken along the length of the non-straight connection member 12. In a preferred embodiment, such as with the connection member 12 of FIG. 4A, the change between symmetric and non-symmetric U-shapes may occur smoothly. However, in an alternative embodiment, the change may be sudden. In some embodiments, the cross-sectional geometry of the connection member varies independently along the length of the connection member. Non-symmetric U-shapes may be non-symmetric by the lengths or angles of the upright portions 26/28, or by the presence or absence of winglets 30/32 or other structures, and/or the angle or length of winglet extension.

In a further detailed aspect of the compression-tension component, the substantially U-shaped portion 44 may be formed by a horizontal base 24 having a top surface 38 and two generally vertical upright portions 26/28. In one embodiment, the generally vertical upright portions at certain cross-sections along the length of the connection member 12 protrude from the top surface of the horizontal base, forming an interior angle 40 in a range of 90°-130°, preferably 90°-120°, more preferably 90°-110°, or about 100°, or about 95°. In this embodiment, a 90° angle may be considered exactly vertical. As shown in FIG. 4E, this interior angle 40 is formed by the inner surface 48 of the upright portion and the top surface 38 of the horizontal base. In another embodiment, certain cross-sections may have one or both generally vertical upright portions forming perpendicular angles with the top surface, meaning that the one or both upright portions are exactly vertical.

In an alternative embodiment, one or both upright portions 26/28 may protrude below the bottom 46 of the horizontal base. An example of this is shown in FIG. 5D, where a cross-section of an alternative connection member has upright portions 60 protruding above and below the horizontal base 62.

As described in the above embodiment, the “U-shape” describes a U made from only three line segments: a base and two sides. In alternative embodiments, the U-shape may be closer to a curved base portion joining two line segments. In another embodiment, rather than a U-shape, a V-shaped cross-section may be used or may be present in a portion of the connection-member, but for purposes of this disclosure and the claims set forth herein, such shape shall be considered U-shaped. In related embodiments, the connection member 12 or the compression-tension component 10 being “non-straight” means that a substantial deviation from a straight configuration or geometry is present (see, for example, the prior art compression member for one variation of a straight configuration—the central member therein is substantially straight notwithstanding certain projections protruding therefrom). Preferably, the non-straight connection member or non-straight compression-tension component is curved. However, in other embodiments, the non-straight parts may be angled, crooked, jagged, or a combination of angled and curved segments.

In one embodiment, one or more portions of the connection member may not have one or both generally vertical upright portions. For instance, the connection member at the cross-section of FIG. 4B does not have any generally vertical upright portion, while the cross-sections of FIGS. 4J and 4K show only one generally vertical upright portion 26. Along the length of the connection member between regions with and without generally vertical upright portions, the height of the generally vertical upright portions may change smoothly.

In one embodiment, a portion or the entire length of the connection member 12 may have a structural ridge 34/36 located on the top surface 38 of the horizontal base. In one embodiment, the connection member may have structural ridges 34/36 that extend towards each other from the first 14 and second 16 ends of the connection member as shown in FIG. 3C. Here, the structural ridges may smoothly reduce in height from the top surface as they extend towards one another and may become flush with the top surface. For instance, in the cross-sections of FIG. 4D and FIG. 4H, the structural ridges (36 and 34, respectively) are visible, but in the cross-sections of FIGS. 4E-4G, the structural ridges are not present.

As mentioned previously, at least a portion of the connection member comprises a cross-sectional geometry that is substantially U-shaped. In one embodiment, the U-shaped cross section may be present in an interior region of the connection member. In one embodiment, the interior region may be about the middle third of the connection member. In another embodiment, the interior region may be any length of the connection member but does not extend to either end of the connection member. In a further embodiment, the interior region is a length that includes the midpoint or middle of the connection member, or includes the midpoint of a line segment connecting the centers of the coupling units 18/20.

In one embodiment, the length of the substantially U-shaped portion 44 may be denoted by the length of the connection member where both generally vertical upright portions 26/28 are present. This length may be 50-95%, preferably 60-90%, more preferably 70-85%, or about 80% of the length of the connection member 12.

In a further detailed aspect of the compression-tension component, the substantially U-shaped portion may comprise a horizontal base 24 and two generally vertical upright portions 26/28 wherein the end of at least one of the upright portions comprises a winglet 30/32 extending outward at an angle to the interior 48 and exterior surfaces 52 of the upright portion. Here, the winglet extending outward at an angle means that a top surface 42 of the winglet forms an angle with the interior 48 and/or exterior surface 52 of the upright portion in a range of 45°-135°, preferably 60°-120°, more preferably 70°-110°, even more preferably 75°-105°.

In an additional aspect, both upright portions each comprise a single winglet, for instance, as shown in FIGS. 4D-4I. In one embodiment, a top surface 42 of the winglet is substantially planar. Further, in lateral cross-sections of the connection member 12, such as FIGS. 4D-4I, the line of the top surface 42 of the winglet is substantially parallel to the top surface of the horizontal base 38. In other words, one or both winglets 30/32 may extend outward horizontally from the upright portions 26/28. However, in other embodiments, or in certain cross-sections of the connection member, one or both winglets 30/32 may extend outward in a way that the top surface 42 of the winglet is at an angle and not substantially parallel to the top surface of the horizontal base 38.

In one embodiment, one or both winglets 30/32 may extend outward at different lengths from the upright portions 26/28 along the length of the connection member. For instance, the top surfaces of the winglets 30/32 in FIG. 3C are seen to extend further away from the top surface of the horizontal base 38 as one moves from the ends of the connection member towards the middle third of the connection member. In an alternative embodiment, one or both winglets may extend inwards from the end of the upright portion. In another alternative embodiment, one or both winglets may extend both inward and outward from the upright portion.

The cross-sectional geometry of the connection member 12 may vary independently extending toward each coupling unit 18/20 from a region in an interior of the connection member where a cross-sectional geometry comprising the substantially U-shaped structure 44 is present. In aspects where the winglet or winglets 30/32 extend horizontally outward, the horizontal extension outward of the winglets may be greatest in the interior region of the connection member 12 and decrease in each direction going toward each end of the connection member as shown, for example, in FIG. 3C.

In one embodiment, the top surface 38 of the horizontal base may be straight in a lateral direction but curved in a longitudinal direction. For instance, the top surface 38 as shown throughout the cross-sections of FIGS. 4B-4K appears horizontal. However, throughout the length of the connection member 12, and as evident by the side views of FIGS. 3B and 4A, the top surface follows curves. From either connection member end 14/16, the top surface follows a positive curvature, then a negative curvature, and then a positive curvature. In one embodiment, the length of the top surface having the negative curvature may be 30-70%, preferably 40-60% of the length of the connection member 12. The total length of the connection member 12 may be defined as the length of a straight line from the first end 14 to the second end 16, or alternatively, as the distance between the coupling units 18/20.

The length of the connection member 12 may be in a range of 10-50 cm, preferably 15-40 cm, more preferably 20-35 cm, even more preferably 25-32 cm, or 28-35 cm, or about 30 cm. In one embodiment, a width of the connection member 12 may be in a range of 2.8-8 cm, preferably 3.2-7.2 cm and may vary throughout the length of the connection member 12. The coupling units may comprise cylindrical holes having diameters in a range of 2.5-5.5 cm, preferably 3.0-5.2 cm, more preferably 3.4-5.0 cm. The upright portions 26/28 and winglets 30/32 may have sidewall thicknesses in a range of 2-10 mm, preferably 3-8 mm, more preferably 4-7 mm. The upright portions 26/28 may independently extend from the top surface 38 of the horizontal base with a maximum height in a range of 1.0-5.0 cm, preferably 1.5-4.5 cm, more preferably 2.2-4.0 cm, or 2.3-3.5 cm. The winglets 30/32 may independently extend from the upright portions 26/28 with a maximum length in a range of 3-20 mm, preferably 4-10 mm. The horizontal base 24 may have a thickness in a range of 5-20 mm, preferably 6-15 mm, more preferably 7-12 mm. The structural ridges 34/36 may extend from the top surface 38 of the horizontal base with a maximum height in a range of 2-10 mm, preferably 3-8 mm. In an alternative embodiment, a cross-section of the connection member may have more than one structural ridge on the top surface of the horizontal base, or may have one or more structural ridges located on an interior or exterior surface 48/52 of an upright portion, on a winglet 30/32, or on the bottom 46 of the horizontal base. For example, in FIG. 5D, an alternative embodiment of a compression-tension component 56 has a linear connection member 58 with three structural ridges 58 on top and bottom surfaces.

In one embodiment, a minimum cross-section area along the connection member 12 may be in a range of 200-550 mm², preferably 250-500 mm², more preferably 300-480 mm², even more preferably 350-450 mm². In one embodiment, a maximum cross-section area along the connection member 12 may be in a range of 400-900 mm², preferably 500-800 mm², more preferably 600-780 mm², even more preferably 650-750 mm².

The compression-tension component 10 may have a mass in a range of 200-500 g, preferably 250-450 g, more preferably 280-400 g, more preferably 300-380 g, more preferably 320-370 g. The compression-tension component 10 may have a density in a range of 0.9-3.5 g/cc, preferably 1.0-3.0 g/cc, more preferably 1.2-2.8 g/cc, even more preferably 1.3-2.2 g/cc, or 1.2-2.0 g/cc, 1.3-1.8 g/cc, 1.3-1.7 g/cc, or about 1.5 g/cc. In one embodiment, the compression-tension component 10 may have a density of 2.5 g/cc or less, 2.2 g/cc or less, 2.0 g/cc or less, 1.8 g/cc or less, 1.6 g/cc or less, 1.5 g/cc or less.

In one embodiment, the bottom of the horizontal base 46 may also be straight in a lateral direction, for instance, as shown in the cross-sections of FIGS. 4B and 4C. The bottom 46 may also have segments that are slightly curved upwards, as shown in the cross-sections of FIGS. 4D, 4H, and 4I. The bottom 46 may further have angled or beveled portions 50 as shown in FIGS. 4E, 4F, 4G, 4J, and 4K. Similar to the top surface 38 of the horizontal base being curved in a longitudinal direction, one or more surfaces of the bottom of the horizontal base 46 may curve while traversing the connection member 12 from one end to the other. This is observed in the side views of FIGS. 3B and 4A, where the lowest point of the bottom 46 is observed to have a series of positive and negative curvatures as discussed for the top surface 38 of the horizontal base. In one embodiment, the lowest point of the bottom 46 may rise above a central axis of the compression-tension component 10, for instance where a central axis is determined by a line segment connecting the centers of the two coupling units 18/20. In one embodiment, a structural ridge 34 may protrude from a portion of the bottom 46, as shown in FIG. 4J.

In one embodiment, the tops of the structural ridges 34/36 are in the same geometric plane, and their height being reduced while extending from the ends of the connection member is a result of the top surface of the horizontal base 38 following a curved path.

In another aspect of this first embodiment of the compression-tension component 10, a cross-sectional geometry of the connection member 12 near a coupling unit may comprise a horizontal base 24 having at least one upright portion different from the substantially U-shaped structure of a cross section near the central region of the connection member. This is seen, for instance, in FIGS. 4C, and 4J-4K.

The fiber reinforced plastic may include one or more mainstream reinforcing fibers, typically selected from the group consisting of carbon fibers, glass fibers, aramid fibers, and all fibers that fit within those, which can include but are not limited to basalt and graphite. Glass fibers and carbon fibers may be preferred, and carbon fibers may be most preferred.

In another aspect of this first embodiment the fiber reinforced plastic may comprise continuous fibers and the continuous fibers may be unidirectional, woven into a fabric or a combination thereof. In one special aspect the continuous fibers are arranged in a substantially uniform microstructure throughout the structure of the compression-tension component.

The tow of the continuous fibers may be from 1K to 80K, preferably from 2 to 30K and most preferably from 3 to 15K.

In further aspects of the first embodiment, the compression-tension component 10 is a molded structure made of one or a combination of three mainstream composite technologies—sheet molding compound (SMC) technology, prepreg (a fiber-resin combination) technology, and/or liquid molding technology (such as resin transfer molding (RTM) or other type). SMC, when used, may exhibit either low flow (e.g. high mold coverage by the material charge) or high flow (low mold coverage by the material charge).

Sheet Molding Compounds (SMC) are a composite sheet material form that is typically available in roll or festoon form, ready for molding. The sheet material is comprised of chopped and typically randomly distributed tows/strands of fibers, sandwiched between thermoset resin film layers. The resin can be polyester, epoxy, vinyl ester, or combinations of other polymers. The length of the fibers varies between 0.5 in. and 4 in., and typically is 1 to 2 in. However, in some applications continuous (infinitely long, as that term is understood in the art) fibers are also used, in particular as local reinforcements. From the SMC roll or festoon, a smaller portion or portions are cut according to the general shape of the part that needs to be molded, and multiple layers are typically stacked on top of each other to reach the desired thickness, volume or weight of the part. This stack is known as a charge. The charge can be small in comparison to the final shape of the part, i.e. significant material flow (movement) will occur so that the material assumes the desired shape, and this process is typically referred to as standard or high-flow molding. Otherwise the charge can be made to be in the exact or near-exact shape of the final part, thus resulting in minimal flow (movement) of the material during molding, and it is typically referred to a low-flow or net-shape molding. The shape and size of the charge has dramatic effects on the performance of the part. The SMC charge is then typically placed in matched metal molds to undergo the curing process, which applies heat and pressure, to be transformed into the final part. This process is typically known as compression molding. However there are exceptions where the SMC charge can be cured with alternate methods, including but not limited to non-metal molds, open molds, and autoclave cycle.

Prepregs are a composite sheet material form that is typically available in roll form. The sheet material is comprised of a thin layer of continuous (infinitely long) fibers, obtained from spreading and collimating the individual tows of carbon fiber, which have been pre-impregnated with a partially solidified (referred to as B-staged) resin bath. The thermoset resin is typically epoxy, but can also include phenolic, cyanate ester, bismalmeidic, or other thermoset polymers. The fibers are typically all aligned in the longitudinal (roll) direction, known as the zero direction, and are therefore referred to as unidirectional prepregs. Otherwise the fibers can be woven together in different directions, including but not limited to the so-called plain weave or twill pattern, and are typically referred to as woven fabrics. From the prepreg roll, several smaller portions are typically cut according to the specific shape of the part that needs to be molded, and multiple layers are typically positioned next to each other and on top of each other to reach the desired shape, thickness, and volume of the part. The orientation of each of these parts is also very significant, since the roll material has only one or few limited material orientations, and the resulting orientation of each portion through the thickness results in what is called the desired stacking sequence. This operation can range from somewhat rough to extremely fine and detailed, and is typically referred to as nesting operation. The arrangement of these small portions into multiple layers and sub-sections next to each other to achieve the desired shape is referred to as lay-up operation. Nesting, stacking sequence, and lay-up procedure have all dramatic effects on the performance of the part. The prepreg lay-up is then typically placed inside a molding tool, which includes but is not limited to matched-metal molds or one-sided non-metallic molds to undergo the curing process, which typically but not always applies heat, vacuum and pressure, to be transformed into the final part. The curing process can take place in an oven, in an autoclave (a type of pressurized oven), and in a heated press, but other methods can be used as well.

Liquid molding is a family of composite processing technology that utilizes liquid thermoset resin to infuse or inject a pre-shaped layer or series of layers of dry fibers. The infusion or injection can take place either in an open mold or in a matched-mold, which can be metallic or non-metallic. The thermoset resin is typically epoxy. The pre-shaped dry fiber layer or layers is typically referred to as the preform, and can be obtained through multiple processes, including but not limited to braiding, thermoforming of individual flat layers, chopping and spraying, or positioning of individual small portions of dry fibers through a nesting, stacking, lay-up operation similar to the one performed with prepreg. The fibers can be both continuous (infinite length) and discontinuous (finite length). Orientation, stacking and shaping of the dry fiber preform has dramatic effects on the performance of the part. The preform is then typically placed inside a molding tool, which includes but is not limited to matched-metal molds or one-sided non-metallic molds to undergo the injection or infusion process, whereby the liquid resin mixture (e.g. resin, catalyst, and hardener) wets and envelops the entire dry preform. The infusion or injection can take place with vacuum only, at high pressure, at low pressure, and at combinations of vacuum and pressure. At that point the curing process initiates, which typically but not always applies heat, vacuum and pressure, to transform the liquid resin around the dry preform into a solid composite final part. The curing process can take place in an oven, in an autoclave (a type of pressurized oven), and in a heated press, but other methods can be used as well. Based on the variety of injection/infusion, curing and molding methods, liquid molding processes include a variety of sub-types of processes, including but not limited to Resin Transfer Molding (RTM), Vacuum Assisted Resin Transfer Molding (VaRTM), Liquid Resin Infusion (LRI), Liquid Compression Molding (LCM), Vacuum Assisted Resin Infusion (VARI), and others.

In further aspects of the first embodiment when the compression-tension component is analyzed under compression loading stress, the substantially U-shaped structure of the interior of the connection member does not comprise a compression-tension stress switching point. In a further additional aspect when the compression-tension component is analyzed under compression loading stress, at least 80% of the length of the connection member 12 does not comprise a compression-tension stress switching point. In other embodiments, when the compression-tension component 10 is analyzed under compression loading stress, at least 82%, at least 85%, or at least 90% of the length of the connection member 12 does not comprise a compression-tension stress switching point. In one embodiment, the compression loading stress may be a result of a compression or tension load of at least 1 kN, at least 5 kN, at least 7 kN, at least 10 kN, at least 15 kN, at least 20 kN, or at least 25 kN. In one embodiment, the compression loading stress may be a result of a compression or tension load of no more than 30 kN, no more than 25 kN, no more than 20 kN, or no more than 15 kN.

In one specific embodiment, the compression-tension component 10 of the first embodiment is a suspension arm for a vehicle. The suspension arm for a vehicle may contain at least one coupling unit or attachment unit 18/20 in the connection member, and in a further aspect the at least one coupling unit comprises a cavity for insertion of a fastening device. Preferably, each end of the suspension arm includes a coupling unit 18/20, as shown in FIGS. 3A-3C. In one embodiment, the connection member 12 may have a side attachment structure 22 as shown in FIGS. 3A, 3B, and in the cross-section of FIG. 4J. In other embodiments, or in different terminology, the compression-tension component may be used or considered as a stabilizer bar, a sway bar, a sway bar link, a control arm, an automotive suspension arm, or a part of a suspension arm assembly.

According to one preferred embodiment of this invention, if the connection member is divided into Y equidistant sections across its length, an axial stress under compression or tension analysis does not change sign over either an upper or lower surface of the connection member across at least 50% of the Y sections, preferably across at least 60% of the Y sections, more preferably across at least 80% of the Y sections, and ideally across 100% of the Y sections.

### EXAMPLE

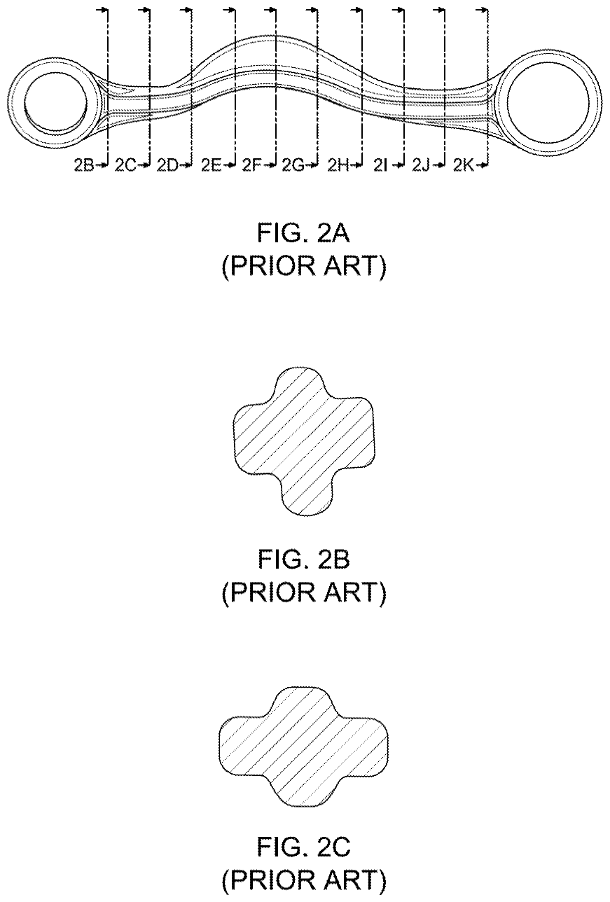

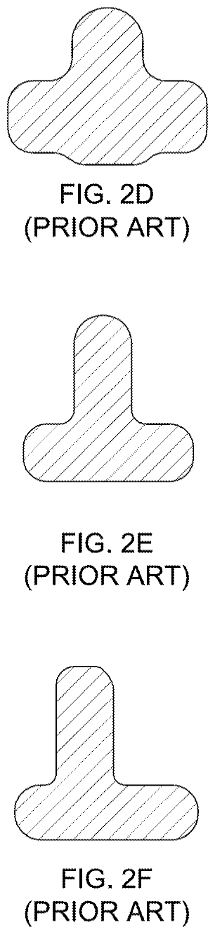

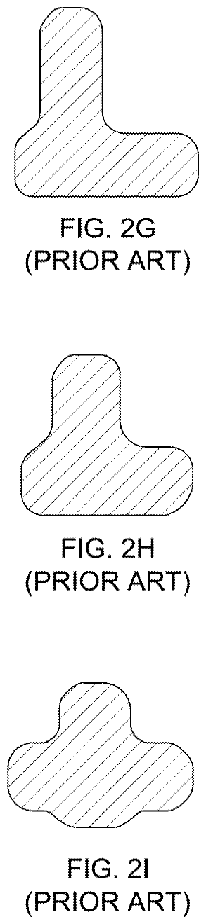

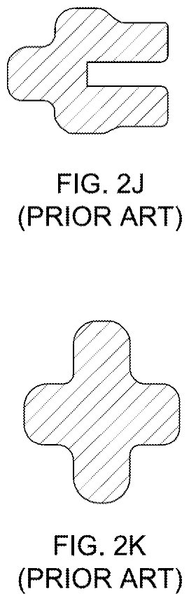

The method of the present invention was applied to the replacement of an aluminum suspension arm shown in FIGS. 1A-1C. FIG. 1B shows a lateral view of a conventional aluminum suspension arm studied for carbon fiber reinforced plastics (CFRP) replacement according to one embodiment of the invention, and FIG. 1C shows a top view of the same suspension arm. FIGS. 2B-2K show cross-sections corresponding to lines 2B-2K along the aluminum suspension arm shown in FIG. 2A. The mass of the forged Al part was 602 g.

In traditional metallic designs such as the forged aluminum part of FIGS. 1A-1C, the suspension arm is designed with a cross-shaped (+) cross-section close to the ends where the eyes are. The cross-shaped cross-section is shown in FIGS. 2B, 2C, and 2K. The suspension arm transitions into a T-shaped cross-section (stiffened beam) toward the center, as shown in FIGS. 2D-2H.

In this study the inventors determined that direct replacement of the forged aluminum with CFRP to make an identically shaped suspension arm could result in a weight reduction of approximately one-half. However, the resulting CFRP arm was inferior in stress performance in comparison to the forged aluminum arm, and thus could not be used to replace the aluminum suspension arm in an automobile. The resulting CFRP arm failed at a lower load than the target, and did not meet desired targets.

In order to prepare a replacement CFRP part for the forged Al suspension arm described in FIGS. 1A-1C and 2A-2K, the inventors redesigned the part within the structural constraints and reevaluated the materials used. This involved designs that reduced stress peaks and improved stress distribution along the length of the suspension arm.

Thus, by coordinated consideration of design and material of construction, an appropriate suspension arm was identified and prepared to replace the original aluminum unit.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A compression-tension component for connecting two mechanical parts, comprising:
a non-straight connection member having two ends and a coupling unit at each end of the connection member;
wherein
the compression-tension component comprises a fiber reinforced plastic,
an average density of the compression-tension component is 1.8 g/cc or less, and
at least a portion of the connection member comprises a cross-sectional geometry which is substantially U-shaped.

2. The compression-tension component according to claim 1, wherein at least a portion of the connection member comprises a cross-sectional geometry which has a symmetric U-shape.

3. The compression-tension component according to claim 1, wherein the fiber reinforced plastic comprises at least one fiber selected from the group consisting of carbon fibers, glass fibers, and aramid fibers.

4. The compression-tension component according to claim 3, wherein the fiber reinforced plastic comprises carbon fibers.

5. The compression-tension component according to claim 1, wherein the substantially U-shaped structure comprises a horizontal base and two generally vertical upright portions wherein an end of at least one of the upright portions comprises a winglet extending outward at an angle to the upright portion.

6. The compression-tension component according to claim 5, wherein an end of both upright portions comprises a winglet extending outward at an angle to the upright portion.

7. The compression-tension component according to claim 5, wherein a top surface of the winglet is substantially parallel to a top surface of the horizontal base.

8. The compression-tension component according to claim 6, wherein a top surface of both winglets is substantially parallel to a top surface of the horizontal base.

9. The compression-tension component according to claim 2, wherein the symmetric U-shaped structure comprises a horizontal base and two equal generally vertical upright portions wherein an end of at least one of the upright portions comprises a winglet extending outward at an angle to the upright portion.

10. The compression-tension component according to claim 9, wherein an end of both upright portions comprises a winglet extending outward at an angle to the upright portion.

11. The compression-tension component according to claim 9, wherein a top surface of the winglet is substantially parallel to a top surface of the horizontal base.

12. The compression-tension component according to claim 10, wherein a top surface of both winglets is substantially parallel to a top surface of the horizontal base.

13. The compression-tension component according to claim 1, wherein the fiber reinforced plastic comprises continuous fibers.

14. The compression-tension component according to claim 13, wherein the continuous fibers are unidirectional or woven into a fabric or a combination thereof.

15. The compression-tension component according to claim 13, wherein the continuous fibers are arranged in a substantially uniform microstructure throughout the structure of the compression-tension component.

16. The compression-tension component according to claim 13, wherein a tow of the continuous fibers is from 1K to 80K.

17. The compression-tension component according to claim 1, wherein the cross sectional geometry of the connection member varies independently extending toward each coupling unit from a region in an interior of the connection member where a cross-sectional geometry comprising the substantially U-shaped structure is present.

18. The compression-tension component according to claim 8, wherein a horizontal extension outward of the winglets is greatest in an interior region of the connection member and decreases in each direction going toward each end of the non-straight connection member.

19. The compression-tension component according to claim 12, wherein a horizontal extension outward of the winglets is greatest in an interior region of the connection member and decreases in each direction going toward each end of the non-straight connection member.

20. The compression-tension component according to claim 1, wherein a cross sectional geometry of the connection member near a coupling unit comprises a horizontal base having at least one upright portion different from the substantially U-shaped structure of the connection member.

21. The compression-tension component according to claim 1, wherein the substantially U-shaped structure comprises a horizontal base and two generally vertical upright portions, wherein a top surface of the horizontal base has at least one structural ridge.

22. The compression-tension component according to claim 21, wherein the top surface of the horizontal base has two structural ridges that each extend toward each other from opposite ends of the connection member.

23. The compression-tension component according to claim 1, wherein under compression loading stress analysis, the substantially U-shaped structure of the connection member does not comprise a compression-tension stress switching point.

24. The compression-tension component according to claim 1, wherein under a compression or tension load, at least 80% of the length of the connection member does not comprise a compression-tension stress switching point.

25. The compression-tension component according to claim 24, wherein the compression or tension load is at least 10 kN.

26. The compression-tension component according to claim 1, wherein the component is a suspension arm for a vehicle.

27. The compression-tension component according to claim 26, further comprising at least one attachment unit in the connection member.

28. The compression-tension component according to claim 27, wherein the connection member further comprises a side attachment structure.

29. The compression-tension component according to claim 27, wherein the at least one attachment unit comprises a cavity for insertion of a fastening device.

30. The compression-tension component according to claim 1, wherein the component is a compression molded structure of at least one of a sheet molding compound (SMC), a prepreg-resin combination, and a liquid molding compound.

31. A suspension member, comprising:
a non-straight arm having two ends and an opening at each end of the arm;
wherein
the suspension member comprises a fiber reinforced plastic,
an average density of the suspension member is 1.8 g/cc or less, and
the suspension member comprises a cross-sectional geometry which is substantially U-shaped.

32. An automotive suspension member, comprising:
a non-straight arm having two ends and an opening at each end of the arm;
wherein
the automotive suspension member comprises a carbon fiber reinforced plastic and the arm is made by a low flow molding process, and
the arm comprises a cross-sectional geometry which is substantially U-shaped.
